(19) United States
(12) Patent Application Publication
(10) Pub. No.: US 2026/0004181 A1
(43) Pub. Date: Jan. 1, 2026

(54) INTELLIGENT ORCHESTRATION

(71) Applicant: International Business Machines Corporation, Armonk, NY (US)

(72) Inventors: Manish Paul, Bangalore (IN); Neeraj Kumar Kashyap, Vinayak Nagar (IN); Jyothi Nagabhushana Rao, Bangalore (IN); Umar Ali Shaik, Bhimadolu (IN)

(73) Assignee: International Business Machines Corporation, Armonk, NY (US)

(21) Appl. No.: 18/756,552

(22) Filed: Jun. 27, 2024

(51) Int. Cl. G06N 20/00

(52) U.S. Cl. CPC G06N 20/00

(57) ABSTRACT

Methods, computer program products, and systems are presented. The method computer program products, and systems can include, for instance: training a machine learning model in dependence on traffic between at least a first service and a second service defining an application; querying the machine learning model; generating service characterizing data that characterizes at least one service defining the application, wherein the generating the service characterizing data is in dependence on the querying of the machine learning model; and modifying a performance attribute of the application in dependence on characterizing data of the service characterizing data.

### BACKGROUND

Embodiments herein relate to orchestration generally and specifically to intelligent orchestration of applications defined by interoperating services.

There are a plurality of cloud based computer environment providers on the market today, each of them offering specific services with service levels, targeting specific use cases, groups of clients, vertical and geographic markets. These cloud providers compete with services of traditional IT service providers which are operated typically in on-premises environments of client owned datacenters. While cloud providers seem to have advantages over said company-owned datacenters, they are not under direct control of the client companies and there is a substantial risk of failure to provide agreed service levels. Furthermore, cloud service providers might change their service levels, prices, and service offerings more often than traditional on-premises (owned by the service consumer) information technology providers.

With the advent of cloud computing, the information technology industry has been undergoing structural changes. These changes not only affect information technology companies themselves, but also the industry in general for which information technology has become an essential part of their business operations. IT departments face the need of providing infrastructure faster, driven by their lines of business, internal clients, suppliers and external customers. On the other hand, the pressure on cost effectiveness and quality of service continues to be very high. A high level of security is of utmost importance. Cloud computer environments have to fulfill similar requirements as traditional data centers in this regard, but are perceived to provide services faster and cheaper, and to have virtually endless resources available.

With container-based virtualization, isolation between containers can occur at multiple resources, such as at the filesystem, the network stack subsystem, and one or more namespaces, but not limited thereto. Containers of a container-based virtualization system can share the same running kernel and memory space. Container based virtualization is significantly different from the traditional hypervisor-based virtualization technology involving hypervisor based virtual machines (VMs) characterized by a physical computing node being emulated using a software emulation layer. Container based virtualization technology offers higher performance and less resource footprint when compared to traditional virtualization and has become an attractive way for cloud vendors to achieve higher density in the datacenter. Thus, containerization (i.e., operating a virtualized data processing environment using container-based virtualization) is changing how workloads are being provisioned on cloud infrastructure.

Data structures have been employed for improving operation of a computer system. A data structure refers to an organization of data in a computer environment for improved computer system operation. Data structure types include containers, lists, stacks, queues, tables and graphs. Data structures have been employed for improved computer system operation e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: training a machine learning model in dependence on traffic between at least a first service and a second service defining an application; querying the machine learning model; generating service characterizing data that characterizes at least one service defining the application, wherein the generating the service characterizing data is in dependence on the querying of the machine learning model; and modifying a performance attribute of the application in dependence on characterizing data of the service characterizing data.

In another aspect, a computer program product can be provided. The computer program product can include a computer readable storage medium readable by one or more processing circuit and storing instructions for execution by one or more processor for performing a method. The method can include, for example: training a machine learning model in dependence on traffic between at least a first service and a second service defining an application; querying the machine learning model; generating service characterizing data that characterizes at least one service defining the application, wherein the generating the service characterizing data is in dependence on the querying of the machine learning model; and modifying a performance attribute of the application in dependence on characterizing data of the service characterizing data.

In a further aspect, a system can be provided. The system can include, for example, a memory. In addition, the system can include one or more processor in communication with the memory. Further, the system can include program instructions executable by the one or more processor via the memory to perform a method. The method can include, for example: training a machine learning model in dependence on traffic between at least a first service and a second service defining an application; querying the machine learning model; generating service characterizing data that characterizes at least one service defining the application, wherein the generating the service characterizing data is in dependence on the querying of the machine learning model; and modifying a performance attribute of the application in dependence on characterizing data of the service characterizing data.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having an orchestrator, user equipment (UE) devices, on-premises computer environments, and computer environments according to one embodiment;

FIG. 2 is an alternative view of the system of FIG. 1 according to one embodiment;

FIG. 3 is a flowchart illustrating a method for performance by an orchestrator interoperating with computer environments according to one embodiment;

FIG. 4 depicts a service classifying predictive model according to one embodiment;

FIG. 5 depicts a method for performance by an orchestrator according to one embodiment;

FIG. 6 depicts querying of a predictive model according to one embodiment;

FIG. 7 depicts a method for performance by an orchestrator according to one embodiment;

FIG. 8 depicts a user interface according to one embodiment;

FIG. 9 depicts an artificial neural network (ANN) according to one embodiment;

FIG. 10 depicts a computing environment according to one embodiment.

### DETAILED DESCRIPTION

In one aspect, embodiments herein can optionally include training a machine learning model in dependence on traffic between at least a first service and a second service defining an application; querying the machine learning model; generating service characterizing data that characterizes at least one service defining the application, wherein the generating the service characterizing data is in dependence on the querying of the machine learning model; and modifying a performance attribute of the application in dependence on characterizing data of the service characterizing data. According to an example of a technical effect of the combination, performance of a service can be optimized.

According to one optional feature, the method includes processing call log entries from a logging data volume and generating from the processing labeled call datasets. According to an example of a technical effect of the combination, performance of a service can be optimized with use of training labels extracted from log entries.

According to one optional feature, the method includes examining call log entries from a logging data volume to generate producer consumer data that specifies a count of instances in which the at least one service defining the application operated as a producer and a count of instances in which the at least one service defining the application operated as a consumer. According to an example of a technical effect of the combination, performance of a service can be optimized based on processing of log entries.

According to one optional feature, the method includes processing call log entries from a logging data volume, and generating from the processing labeled call datasets, wherein the call log entries reference calls between services hosted on one or more computer environment, and wherein the training the machine learning model includes training the machine learning model with use of the labeled call datasets. According to an example of a technical effect of the combination, performance of a service can be optimized with use of training labels extracted from log entries.

According to one optional feature, the method includes processing application program interface (API) documentation using natural language processing to generate service profile data of a plurality of services defining the application, wherein the service profile data associates at least one of an endpoint or API path to service identifiers of respective ones of the plurality of services, wherein the method includes processing call log entries from a logging data volume, and generating from the processing labeled call datasets that are enriched with service identifiers extracted by query of the service profile data, wherein the call log entries reference calls between services hosted on one or more computer environment, and wherein the training the machine learning model includes training the machine learning model with use of the labeled call datasets. According to an example of a technical effect of the combination, performance of a service can be optimized based on processing of API documentation.

According to one optional feature, the method includes processing return code data of call log entries from a logging data volume, and generating from the processing labeled call datasets, wherein labels of the labeled call datasets depend on the return code data processed by the processing, wherein the call log entries reference calls between services hosted on one or more computer environment, and wherein the training the machine learning model includes training the machine learning model with use of the labeled call datasets. According to an example of a technical effect of the combination, performance of a service can be optimized based on processing of return code data.

According to one optional feature, the method includes examining call log entries from a logging data volume to generate producer consumer data defining the service characterizing data that specifies a count of instances in which the at least one service defining the application operated as a producer and a count of instances in which the at least one service defining the application operated as a consumer, and wherein the generating the service characterizing data is in dependence on the examining. According to an example of a technical effect of the combination, performance of a service can be optimized based producer consumer count data.

According to one optional feature, the method includes processing call log entries from a logging data volume, and generating from the processing labeled call datasets, wherein the call log entries reference calls between services hosted on one or more computer environment, wherein the training the machine learning model includes training the machine learning model with use of the labeled call datasets, wherein the querying of the machine learning model produces a criticality status classifier for the at least one service defining the service characterizing data, wherein the method includes examining call log entries from a logging data volume to generate producer consumer data defining the service characterizing data that specifies a count of instances in which the at least one service defining the application operated as a producer and a count of instances in which the at least one service defining the application operated as a consumer, wherein the generating the service characterizing data is in dependence on the examining, wherein the modifying the performance attribute of the application in dependence on characterizing data of the service characterizing data includes modifying the performance attribute of the application in dependence on the criticality status classifier and in dependence on the producer consumer data. According to an example of a technical effect of the combination, performance of a service can be optimized based on training of a machine learning model.

According to one optional feature, the method includes modifying the performance attribute of the application in dependence on characterizing data of the service characterizing data includes updating an orchestration process of the application. According to an example of a technical effect of the combination, performance of an orchestration process can be optimized.

According to one optional feature, the method includes the modifying the performance attribute of the application in dependence on characterizing data of the service characterizing data includes updating a recovering plan for recovery of the application, wherein the updating the recovering plan for recovery of the application includes executing a call to increase a data replication rate at which data of the at least one service is replicated into a backup storage volume. According to an example of a technical effect of the combination, performance of a recovery orchestration service can be optimized.

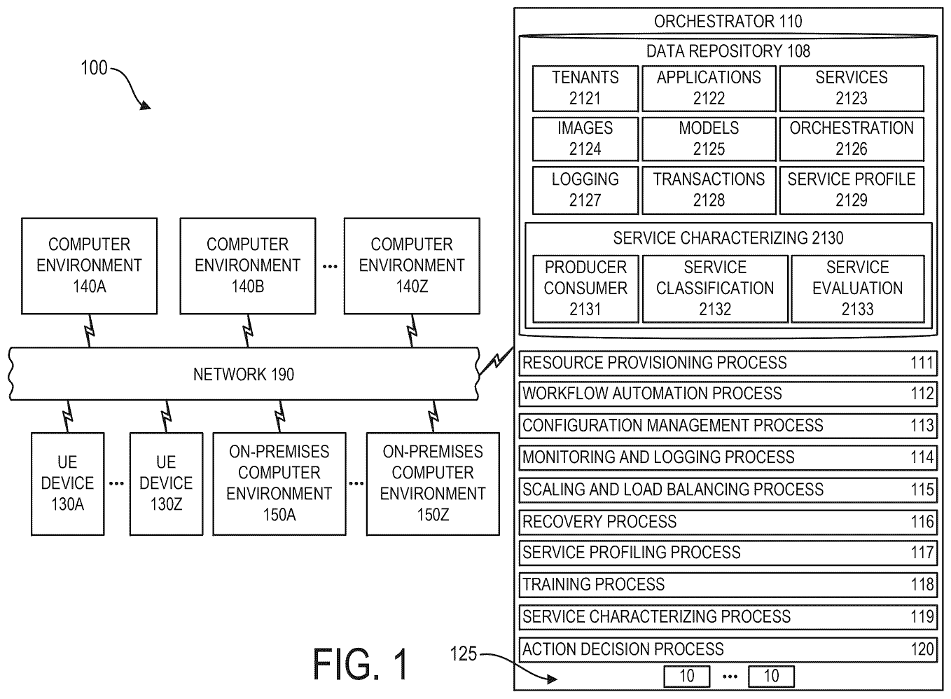

System 100 for use in characterizing application services is shown in FIG. 1. System 100 can include orchestrator 110 having an associated data repository 108, user equipment UE devices 130A-130Z, computer environments 140A-140Z, and on premises computer environments 150A-150Z. Orchestrator 110, UE devices 130A-130Z computer environments 140A-140Z and on-premises computer environments 150A-150Z can be in communication with one another via network 190. System 100 can include numerous devices which can be computing node-based devices connected by network 190. Network 190 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network.

Embodiments herein recognize that orchestration can involve multiple entities. Entities involved in an application orchestration can include a requesting entity, i.e., a tenant user that requests orchestration of an application and orchestrator entity that performs orchestration. In reference to FIG. 1, orchestration can be performed by an entity that operates orchestrator 110 and requesting entity can be a tenant user having tenant data stored in tenant area 2121 of data repository 108. An individual tenant user of system 100 can operate an on-premises computer environment of computer environments of on premises computer environments 150A-150Z. In addition to a requesting entity and an orchestration entity, embodiments herein recognize that orchestration can also involve a third-party entity, e.g., an entity that operates a computer environment of computer environments 140A-140Z.

Computer environments 140A-140Z of system 100 can be associated to respective computing environment providers. According to one embodiment, where computer environments 140A-140Z are configured as cloud computing environments computing environment providers associated to respective computing environments 140A-140Z, can be providers known as cloud services providers, e.g., having characteristics in common with such available services as IBM® CLOUD® cloud services, AMAZON® WEB SERVICES® (AWS®), or MICROSOFT® AZURE® cloud services (IBM® and IBM CLOUD are registered trademarks of International Business Machines Corporation, AMAZON®, AMAZON WEB SERVICES® and AWS® are registered trademarks of Amazon.com, Inc, and MICROSOFT® and AZURE® are registered trademarks of Microsoft Corporation.) In one embodiment, orchestrator 110 can be collocated with a computer environment of computer environments 140A-140Z.

Data repository 108 can store various data. Data repository 108 in tenants area 2121 can store data on tenants users who have requested that their applications be orchestrated by orchestrator 110.

Data repository 108 in applications area 2122 can store data on applications for which orchestration requests have been received. Applications for orchestration can reference one or more service. An application orchestration requests can specify an application service hosted on a particular environment, e.g., an environment of computer environments 140A-140Z or an environment of an on-premises computer environment 150A-150Z associated to particular tenant users.

Orchestrator 110 in services area 2123 can store data on specified services defining an application. Services can include, e.g., the COS service, the key protect service, a VPC service, an extensible service, an IAM service, and a container hosting service, e.g., Kubernetes, as well as various orchestration services involving, e.g., resource provisioning, workflow automation, configuration management, monitoring and logging, scaling and load balancing, and recovery.

Data repository 108 in images area 2124 can store software images. A software image is a file or a set of files that contain the complete state of a computer system's software, including the operating system, applications, and configuration settings. It is essentially a snapshot of a system at a particular point in time, which can be used to create a new system with the same configuration or to restore a system to a previous state. Software images can be used to replicate the same environment across multiple environments such as environments of computer environments 140A-140Z and/or environments of on premises computer environments 150A-150Z.

Data repository 108 in models area 2125 can store models training by machine learning processes. In one aspect, models of models area 2125 can store a predictive model trained to return criticality status information on being queried.

Data repository 108 in orchestration registry 2126 can store parameter values that control operations of an orchestration service, e.g., involving resource provisioning, workflow automation, configuration management, monitoring and logging, scaling and load balancing, and/or recover recovery. Orchestrator 110 can be configured to query orchestration registry 2126 to update operations of orchestration services, e.g., scaling services, load balancing services, recovery services in dependence on characterizing data of service characterizing data herein. Orchestrator 110 updating operations of orchestration services, e.g., scaling services, load balancing services, recovery services in dependence on characterizing data of service characterizing data herein can include orchestrator 110 generating calls for modifying attributes of, e.g., scaling services, load balancing services, recovery services in dependence on characterizing data of service characterizing data herein, and executing such calls.

Data repository 108 in logging volume 2127 can store logging data. Logging data can include records of requests made between services including access logs that record requests made between services defining an application. Access logs can provide information about the entity making a request, subject matter of the request, the method of the request, and the response to the request. An access log can include such information as information that specifies: transaction ID, service endpoint, API path, method, source service, target service and return code (which can include, e.g., a response code that indicates the result of an HTTP request).

Data repository 108 in transactions registry 2128 can store calls defining transactions that have executed involving services defining an application. A transaction can be defined by a plurality of calls which together defining a logical item of work.

Data repository 108 in service profiles area 2129 can include service profile data specifying attributes of respective services defining an application. Service profile data of service profiles area 2128 can include, e.g., a specifier for a service endpoint and API paths, as well as summary data summarizing dependent services.

Data repository 108 in service characterizing registry 2130 can store various service characterizing data including producer consumer service characterizing data stored in producer consumer registry 2131, service classification characterizing data stored in service classification registry 2132, and service evaluation characterizing data stored in service evaluation registry 2132.

In further aspect, orchestrator 110 can manage one or more cluster 125. One or more cluster 130 can include, e.g., a plurality of computing nodes 10 hosting various services. In one aspect a subset of computing nodes 10 can define backup storage volumes for storage of backup services data.

Orchestrator 110 can run various processes including processes that can be realized with orchestration services. Orchestrator 110, running resource provisioning process 111, can allocate and manage computing resources, e.g., CPU, working memory, storage memory resources, to ensure efficient use of competing resources. Other functions such as preventing resource contentions.

Orchestrator 110 running workflow automation process 112 can include orchestrator 110, managing and automating workflows, e.g., by defining and/or executing a succession of tasks in a specific order. Orchestrator 110 running configuration management process 113 can include orchestrator 110 managing configuration settings and can further include orchestrator 110 ensuring consistency across environments on which services are hosted.

Orchestrator 110 running scaling and load balancing process 115 can include orchestrator automatically scaling up resources or scaling down resources based on demand and distributing workloads for assurance of optimal performance and availability.

Orchestrator 110 running recovery process 116 can include orchestrator 110 detecting and handling errors and automatically recovering processes for purposes, e.g., of minimizing downtime and ensuring resilience. Orchestrator 110 running recovery process 116 can include orchestrator 110 establishing and updating a recovery plan. As part of updating a recovery plan, orchestrator 110 can, e.g., update a replication frequency of service data, and/or reconfigure a failover process associated to the service in dependence on characterizing data of service characterizing data as set forth herein.

Orchestrator 110 running service profiling process 117 can include orchestrator 110 generating for respective services of system 100 service profiles. In one aspect, orchestrator 110 running service profiling process 117 can include orchestrator 110 subjecting application program interface API documentation to natural language processing and responsive derivation of dependencies between services.

Orchestrator 110 running training process 118 can include orchestrator 110 training one or more predictive models stored in models area 2124 using data of profile data generated by orchestrator 110 running service profiling process 117. In one aspect, orchestrator 110 running training process 118 can include orchestrator 110 training a machine learning model using training data defined by data of profile data output by orchestrator 110 running service profiling process 117.

Orchestrator 110 running characterizing process 119 can include orchestrator 110 characterizing respective services defining an application. Orchestrator 110 running characterizing process 119 can include orchestrator 110 generating, e.g., service classification characterizing data, service producer consumer characterizing data, service evaluation characterizing data. Orchestrator 110 generating criticality status characterizing data can include orchestrator 110 querying a trained predictive machine model that has been trained in dependence on services traffic. Orchestrator 110 generating producer consumer characterizing data can include orchestrator 110 processing call log entries. Orchestrator 110 generating evaluation characterizing data can include orchestrator 110 generating a ranked ordered list of services in dependence on data of service classification data and data of service producer consumer data.

Orchestrator 110 running action decision process 120 can return an action decision in dependence on a result of orchestrator 110 running characterizing process 119. Orchestrator 110 running action decision process 120 can include orchestrator 110 returning an action decision e.g. to control operations of an orchestration service by orchestrator 110, e.g., involving resource provisioning, workflow automation, configuration management, monitoring and logging, scaling and load balancing, and recovery.

Orchestrator 110 can also run a Natural Language Processing (NLP) process for determining one or more NLP output parameter of text data. Orchestrator 110 running an NLP process can include one or more of a topic classification process that determines topics of messages and output one or more topic NLP output parameter, a sentiment analysis process which determines sentiment parameter for a message, e.g., polar sentiment NLP output parameters, “negative,” “positive,” and/or non-polar NLP output sentiment parameters, e.g., “anger,” “disgust,” “fear,” “joy,” and/or “sadness” or other classification process for output of one or more other NLP output parameters e.g., one of more “social tendency” NLP output parameter or one or more “writing style” NLP output parameter.

By running of the described NLP process, orchestrator 110 can perform a number of processes including one or more of (a) topic classification and output of one or more topic NLP output parameter for a received message (b) sentiment classification and output of one or more sentiment NLP output parameter for a received message or (c) other NLP classifications and output of one or more other NLP output parameter for the received message.

Topic analysis for topic classification and output of NLP output parameters can include topic segmentation to identify several topics within a message. Topic analysis can apply a variety of technologies e.g., one or more of Hidden Markov model (HMM), artificial chains, passage similarities using word co-occurrence, topic modeling, or clustering. Sentiment analysis for sentiment classification and output of one or more sentiment NLP parameter can determine the attitude of a speaker or a writer with respect to some topic or the overall contextual polarity of a document. The attitude may be the author's judgment or evaluation, affective state (the emotional state of the author when writing), or the intended emotional communication (emotional effect the author wishes to have on the reader). In one embodiment sentiment analysis can classify the polarity of a given text as to whether an expressed opinion is positive, negative, or neutral. Advanced sentiment classification can classify beyond a polarity of a given text. Advanced sentiment classification can classify emotional states as sentiment classifications. Sentiment classifications can include the classification of “anger,” “disgust,” “fear,” “joy,” and “sadness.”

Orchestrator 110 running the described NLP process can include orchestrator 110 returning NLP output parameters in addition to those specification topic and sentiment, e.g., can provide sentence segmentation tags, and part of speech tags. Orchestrator 110 can use sentence segmentation parameters to determine e.g., that an action topic and an entity topic are referenced in a common sentence for example.

Applications for which orchestration can be requested can include, e.g., web applications, mobile applications, enterprise applications, collaboration tool applications, development and testing applications, data analytics and an business intelligence applications, machine learning applications, content delivery applications, gaming applications, healthcare applications, Internet of things applications, financial services applications, streaming media applications, and virtual desktop applications. There can be included in a request for hosting an application a request for various services supporting the hosting. Services supporting an defining an application can include, e.g., key protection services, cloud objects storage (COS) service, a cloud storage service, virtual private cloud (VPC) service, which can provide a tenant user with a logically isolated section of a public cloud and identity and access management (IAM) service which is a framework and policies and technologies for ensuring that the authenticated individuals and entities, e.g., applications or devices have appropriate access to resources. Services can also include various web hosting services that allow users to rent virtual servers known as instances to run their applications. Services can include extensible hosting services and container management services. Services defining an application can include various orchestration services set forth herein.

In one embodiment, applications herein can be hosted with use of a service mesh. A service mesh can refer to infrastructure layer designed to manage, secure, and monitor communication between microservices within a distributed application, providing processes to connect, secure, and observe various interactions between services. A service mesh can facilitate advanced traffic management, such as load balancing, service discovery, and routing, as well as enhanced security features, e.g., mutual TLS for service-to-service encryption and fine-grained access control. In one variation, a service mesh can include a network of lightweight proxies deployed alongside each service instance, often referred to as sidecars, which handle the communication between services, abstracting the complexity away from the application code. In one aspect, a service mesh can capture detailed metrics, logs, and traces of service interactions, which can be used for monitoring, debugging, and improving performance.

Embodiments herein recognize that a received orchestration request can reference a service hosted on a computer environment of a third-party entity, i.e., an entity other than the requesting entity and other than the orchestrator entity. In one illustrative use case, a requesting tenant user (first entity) can request orchestration to an orchestrator 110 operated by a first entity. In one illustrative use case, the requesting tenant user (first entity) can request orchestration of an application that references services hosted on various computer environments, including, e.g., services hosted on a computer environment of an entity in common with the orchestrating entity (second entity) and second one or more service hosted on a computer environment of a third-party entity, e.g., an entity other than the requesting entity and other than the orchestration entity. In one illustrative use case, a tenant user may wish primarily to move hosting to a new cloud provider but retain some limited services with a prior provider. According to one example, retaining a portion of services with the prior primary provider can be helpful for compliance, e.g., with privacy requirements, customer requirements, SLA requirements and the like.

Embodiments herein recognize that in the context of orchestration, information on services hosted by orchestration entity or an orchestration requesting entity can be relatively comprehensive and accessible, e.g., an entirety of source code and other documentation associated to the service can be attainable and digestible. On the other hand, embodiments herein recognize that process driving information on services can be limited in the case that services are hosted on a computer environment of a third-party entity other than an orchestration entity and requesting entity.

While enhanced service characterizing data herein can drive processes to improve performance to all services herein whether hosted on a tenant computer environment, orchestration entity computer environment, or third-party computer environment, additional advantages can accrue in the case of a service hosted on a third-party computer environment in view of challenges that persist in characterizing such services from the perspective on an orchestrator.

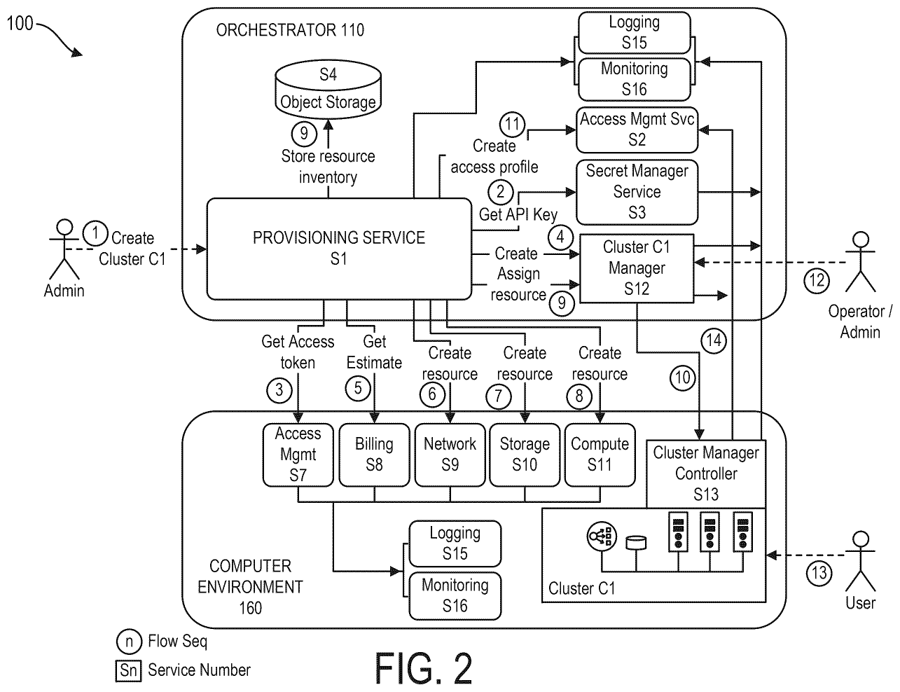

FIG. 2 depicts various orchestration services of orchestrator 110 interoperating with other services hosted on external computer environment 160. FIG. 2 depicts Provisioning Service (PS) S1 interoperating with various other services labeled S2-S16. Services S1, S2, S3, S12, S15, and S16 can be hosted on computer environment 160 and services S7, S8, S9, S10, S11, S15, and S16 are hosted on computer environment 140A. In one embodiment, computer environment 160 represents a tenant user computer environment of computer environments 150A-150Z. In one embodiment, computer environment 160 represents a computer environment of computer environments 140A-140Z, wherein the computer environment is operated by an entity in common with orchestrator 110. In one embodiment, orchestrator 110 can be collocated with a computer environment of computer environments 140A-140Z, wherein the computer environment is operated by an entity in common with orchestrator 110. In one embodiment, computer environment 160 represents a computer environment of computer environments 140A-140Z, wherein the computer environment is a third-party computer environment operated by an entity other than an entity operating orchestrator 110, and other than the tenant user.

PS service S1 can be based on Ansible and Terraform. Ansible can provide, e.g., configuration management, application deployment, and task automation using simple, human-readable YAML language, making it easy to manage systems and software configurations. Terraform can, e.g., enable users to define and provision infrastructure resources across various cloud providers and services using a declarative configuration language, allowing for the versioning, reproducibility, and scalability of infrastructure deployments.

Referring to FIG. 2, Cluster C1 can refer to a set of Computes with Storage connected over a network, hosting required controller services and customer's workload. Cluster Manager C1 service S12 can refer to a service created in computer environment 140A defining a Primary Cloud. Cluster Manager C1 service S12 can provide the interface to manage the Cluster(s). Cluster Manager Controller S13 is a set of services to monitor and manage the Cluster C1 in computer environment 160.

In cloud computing, a transaction refers to a sequence of operations performed as a single logical unit of work, which ensures consistency, reliability, and integrity of data across distributed systems. Transactions in cloud environments often involve multiple services and resources, such as databases, microservices, and external APIs, and are governed by the principles of ACID (Atomicity, Consistency, Isolation, Durability). In cloud computing, transactions can span across multiple distributed resources, making transaction management more complex but essential for maintaining the overall integrity and reliability of cloud-based applications and services. This often involves using specific transaction management protocols and tools designed for distributed environments, such as distributed transaction coordinators, Two-Phase Commit (2PC), and eventual consistency mechanisms.

Example transactions that can be performed during a deployment period of an application can include, e.g., provisioning and deprovisioning virtual machines, storing and retrieving data in cloud storage services, and managing databases through cloud-based platforms. Users frequently scale resources up or down based on demand, execute automated software deployments, and perform backup and disaster recovery operations. Additionally, transactions often involve network configurations, such as setting up virtual private networks (VPNs) and managing security policies through identity and access management (IAM) services. Transactions can involve, e.g., provisioning virtual machines, scaling resources, data storage and retrieval, database management, backup disaster recovery, software deployment, network configuration, identity and access management, monitoring and logging, user registration and logging, video upload and processing, order fulfillment, database backup and restoration, and the like.

In Table A there is set forth a set of operations 1-13 defining a resource provisioning transactions, wherein operations of the transaction can be performed through a set of service calls between ones of the services.

TABLE A

| Operation | Description |
|---|---|
| 1 | Authenticated consumer (Admin), after securely storing the Cloud Access Secrets in |
| | Secret Manager service, requests PS service S1 to provision Cluster C1 in Cloud A |
| 2 | PS service S1, extracts API Key from Secret Manager service (S3) based on the user |
| | provided input. |
| 3 | PS service S1 gets access token from Access Mgmt. service (S7) |
| 4 | PS service S1 creates Cluster Manager service (S12) |
| 5 | Fetch the cost estimates as per the resource plan from Billing service (S8) |
| 6 | Once approved by the Admin., create the network resources. |
| 7 | Create storage resources |
| 8 | Create server resources |
| 9 | Assign the server resources to Cluster Manager (S12) |
| 10 | Create Cluster Manager Controller (S13) |
| 11 | Create access profiles for the Cluster in IAM (S2) |
| 12 | Operators try to access the Cluster, validate access permission, with IAM (S2) as per |
| | profile |
| 13 | Operators try to access the Cluster, validate access permission, with IAM (S2) as per |
| | profile |

In reference to Table A, operations 1-11 can map to calls defining a first transaction, operation 12 can map to calls defining a second transaction, and operation 13 can map to calls defining a third transaction.

In one aspect, all services managed by orchestrator 110 can be forwarding the logs and metrics to the Logging (S5) and Monitoring (S6) Service, where S5 and S6 are hosted on orchestrator 110. All services managed by computer environment 160 can be forwarding the logs and metrics to the Logging (S15) and Monitoring (S16) Service, where S15 and S16 are hosted in computer environment 160. Logging (S15) and Monitoring (S16) Service in turn can be forwarding their logs to Logging (S5) and Monitoring (S6) Service of orchestrator 110, where computer environment 160 is a tenant on premises computer environment of computer environments 150A-150C, where computer environment 160 is operated by an entity in common with orchestrator 110, or where orchestrator 110 otherwise has access rights to such logging data. Further, even in the case where computer environment 160 is a third-party computer environment and orchestrator 110 does not have access rights to logging data thereof, orchestrator 110 by way of methods herein can generate comprehensive process driving characterizing data of services hosted on computer environment 160 based on traffic to and from services hosted on computer environment 160.

In Cloud, the services communicate with each other using REST API or Message Queue. Here, the assumption is the participating services are using REST API. As per the Monitoring and Observability guidelines and best practices, the production grade Cloud native services generates logs, metrics (to measure latency, traffic, response code/errors and bottlenecks) and Events. The logs are stored by Logging service (S5 or S15) and Events and Metrics are stored by Monitoring service (S6 or S16).

For support of processes herein the following REST API attributes can be extracted from a logging and monitoring service: Source service, Endpoint, REST API path, Method (GET, PUT, POST, PATCH), and response code.

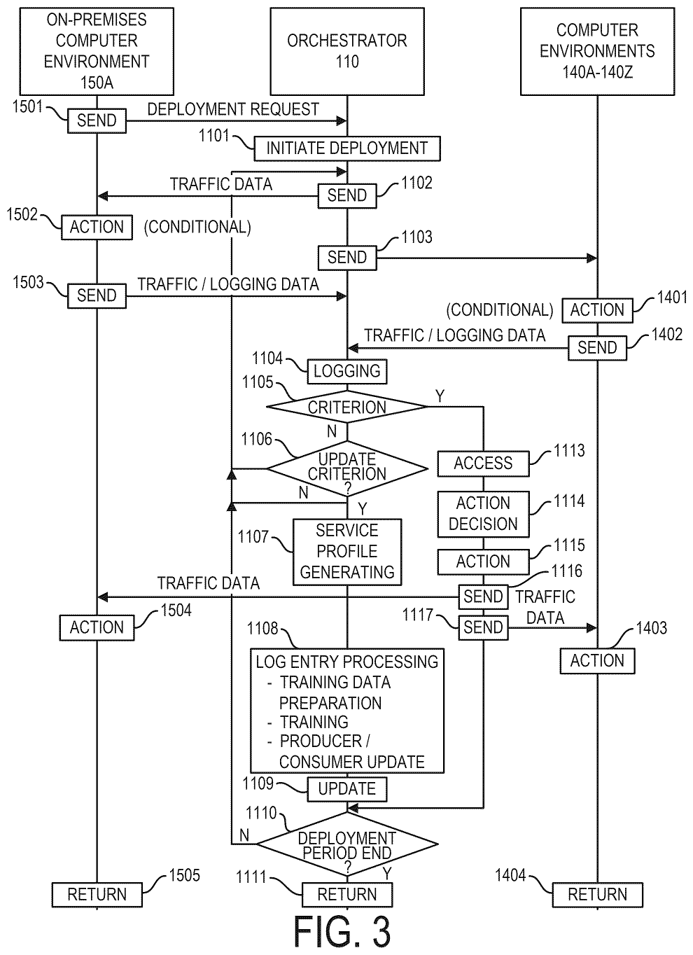

A method for performance by orchestrator 110 interoperating with on premises computer environment 150A of a requesting tenant user and computer environments 140A-140Z is depicted in the flowchart of FIG. 3. In response to the deployment request sent at block 1501, orchestrator 110 can initiate deployment at block 1101. Initiating deployment can include triggering calls such as calls in support of the operations 1 to 11 set forth in reference to Table A and FIG. 2.

On initiating deployment, orchestrator 110 can proceed to send block 1102. At send block 1102, orchestrator 110 can send traffic data to on-premises computer environment 150, where, for the particular deployment, services are to be hosted on an on-premises computer environment 150A. In response to the traffic data received, on-premises computer environment 150A can perform any action that is specified by the traffic data sent at block 1102, e.g., installing or de-installing, a service and the like. On completion of conditional action block 1502, on-premises computer environment 150A can proceed to send block 1503. At send block 1503, on-premises computer environment 150A can send traffic and/or logging data for receipt by orchestrator 110.

At send block 1103, orchestrator 110 can send traffic data for receipt by computer environments 140A-140Z. In response to the traffic data received, computer environments 140A-140Z can perform any action that is specified by the traffic data sent at block 1103, e.g., installing or de-installing, a service and the like. On completion of conditional action block 1401, computer environments 140A-140Z can proceed to send block 1402. At send block 1402, computer environments 140A-140Z can send traffic and/or logging data for receipt by orchestrator 110. As noted with reference to FIG. 2, external clouds, e.g., computer environment 160 can under various scenarios push their logging data for receipt by logging volume 2127 of data repository 108.

In response to the traffic and/or logging data, orchestrator 110 can perform logging at block 1104. Logging at block 1104 can include orchestrator 110 logging Rest API calls to logging volume 2127, including logging of API calls internally by orchestrator 110 and external messaging calls. Logging at block 1104 can be performed on an ongoing basis by orchestrator 110. In performing logging, orchestrator 110 can store logging data into logging volume 2127.

In performing logging at logging block 1104 on an ongoing basis, orchestrator 110 can proceed to criterion block 1105. At criterion block 1105, orchestrator 110 can determine whether a criterion has been satisfied for access to service characterizing registry 2130 of data repository 108. service characterizing data of service characterizing registry 2130 can drive a variety of processes, e.g., workflow automation processes, resource provisioning processes, configuration management processes, monitoring and logging processes, scaling and load-balancing processes, and recovery processes. Service characterizing registry 2130 can be iteratively updated by processes herein.

On determining that a criterion for access of service characterizing data 2130 is not satisfied, orchestrator 110 can proceed to update criterion decision block 1106. At update criterion decision block 1106, orchestrator 110 can ascertain whether a criterion for updating service characterizing registry 2130 has been satisfied.

On determining at block 1106 that an update criterion has been satisfied, orchestrator 110 can proceed to service profile generating block 1107. At service profile generating block 1107, orchestrator 110 can generate service profile data for services defining deployed application. Orchestrator 110 at service profile generating block 1107 can generate service profile data with use of natural language processing optimized with one or more large language model (LLM), which has been fine-tuned with iterations of fine-tuning training data. Fine tune training of an LLM can be performed to train an LLM to extract targeted data items from API documents associated to the various services defining the application. Orchestrator 110 producing service profile data at service profile generating block 1107 can include orchestrator 110 consuming API documentation and subjecting the API documentation to natural language processing for production of a service profile for respective services defining an application. API documentation can include, e.g., a text-based description of the API's functionality, endpoints, request and response formats, and authentication methods. An API document can specify, e.g., details each endpoint's URL, HTTP methods (GET, POST, PUT, DELETE), required and optional parameters, and data types. Examples of requests and responses, including error codes and messages, can be provided within an API document to illustrate proper usage. Additionally, API documentation often includes rate limits, versioning information, and usage guidelines. Some documentation may also offer SDKs, code snippets, and interactive tools for testing API calls to facilitate integration and development. In one example, orchestrator 110 can parse request data from a tenant user sent at block 1501 and orchestrator 110 for references to services and orchestrator 110 can search public data sources for API documentation for services. In another example, an administrator use can load API documents for processing at block 1107 into services area 2123 for processing.

An example of a generated service profile for a service is set forth in Table B.

TABLE B
serviceProfile:

Service: Network(VPC)
Description: A VPC is a virtual network that belongs to an account and provides logical isolation

from other networks.

| Endpoint: [URL listed] | |
|---|---|
| APIs: | |
| - | path: “/v1/vpcs/{vpc_id}” |
| | Method: GET |
| | Data: |

input:

| | |
|---|---|
| - | VPC ID |

output:

| | |
|---|---|
| - | Network ACL |
| - | Routing Table |
| - | Security Group |
| - | DNS |

| | |
|---|---|
| - | Path: “/v1/vpcs/{vpc-id}/routing_tables/{id}” |
| | Method: GET |
| | Data: |

input:

| | |
|---|---|
| - | VPC ID |
| - | Routing Table ID |

output:

| | |
|---|---|
| - | Routes |
| - | Attached Subnets |

| | |
|---|---|
| - | Path: “/v1/vpcs/{vpc-id}/routing_tables/{table_id}/routes/{id}” |

Method: PATCH
Data:

input:

| - | VPC ID | |
|---|---|---|
| - | Routing Table ID | |
| | - | Route ID |

| | |
|---|---|
| - | Name |

output: [ ]

| Dependencies: | |
|---|---|
| - | Service: Access Mgmt |
| | Endpoint: https://iam.cloud-a.com |

As set forth in Table B, a service profile for certain service can include, e.g., specifiers for a service endpoint, specifiers for endpoint API paths, and specifiers for dependent services dependent on the service referenced in the service profile.

On completion of service profile generating at block 1107, orchestrator 110 can proceed to log entry processing block 1108. At log entry processing block 1108, orchestrator 110 can process call log entries that have accumulated in logging volume 2127. At log entry processing block 1108, orchestrator 110 can perform, e.g., generating training data labels, training a service classifying predictive model, and updating a producer consumer table.

The format for an API call log entry is set forth in Table C.

TABLE C
{“txn-id”:”xyz123”, “source”: “svc1”, “api endpoint”: “abc.svc6.com”, “api”: “v2/resource-x”,
“method”: “POST”, “return-code”: “200”, “latency”: “10s”}
{“txn-id”:”xyz123”, “source”: “svc1”, “api endpoint”: “xyz.svc11.com”, “api”: “v2/resource-y”,
“method”: “POST”, “return-code”: “200”, “latency”: “2s”}

For performing training data preparation, orchestrator 110 at log entry processing block 1108 can initially enrich call log entry data with extracted service profile data from service profiles registry 2129. For performing training data preparation, orchestrator 110 at log entry processing block 1108 can further parse each log entry to ascertain a return code status. Where orchestrator 110 determines that the return code for a log entry is “failed” orchestrator 110 can assign an is Critical label to the log entry and call.

The criticality status label can alternatively be raised with use of related services database that can be periodically updated by an administrator user to force criticality labels for certain access log data entries. Embodiments herein recognize that expert administrator users can become aware of situations where a pre-configured flag can benefit operation of an environment. Orchestrator 110 can set the label “critical” or alternatively “not critical” to each API call log entry of certain service pairs. Orchestrator 110 can output a call dataset for each call log entry based on the described processing, enriched with service identifiers, and labeled according to the described labeling process.

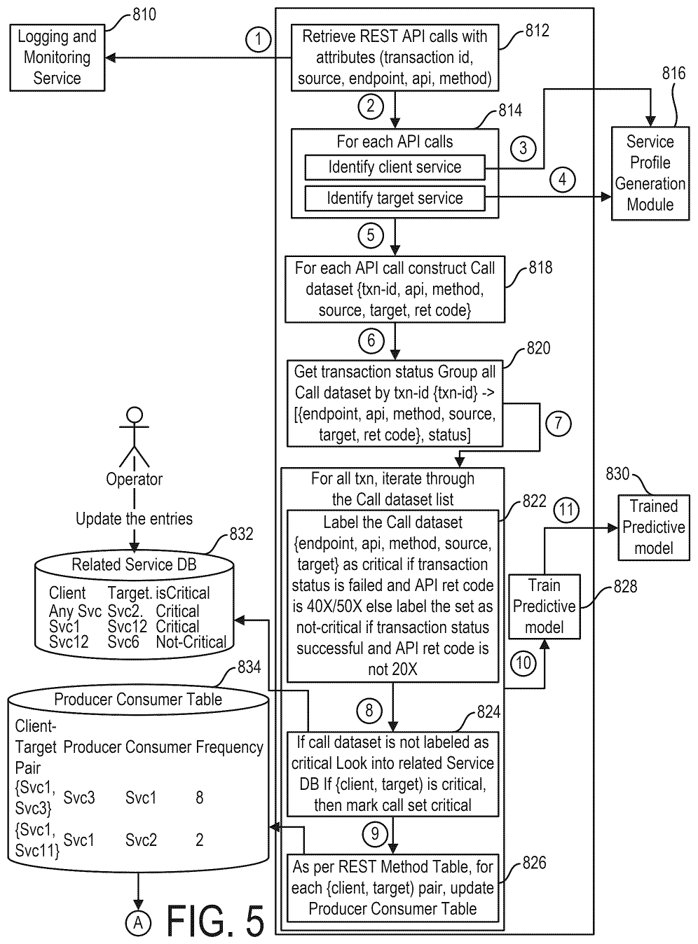

Once the labels for each call are assigned, orchestrator 110 can train service classifier predictive model 5102 as set forth in FIG. 5 using the collected, processed and now-labeled training data prepared at block 1108. Iterations of training data for training predictive model 5102 can include the labeled call datasets in dependence on the described processing of records of historical API calls stored in logging volume 2127 labeled as described in connection with block 1108. In reference to FIG. 5, each iteration of training data can include, as input training data, (a) a call dataset extracted in dependence on processing an historical API call log entry associated to (b) the generated critical/not critical label defining outcome training data generated as described at block 1108.

Trained as described, service classifying predictive model 5102 is able to return a prediction as to a service classification in response to being queried with API call data.

Orchestrator 110 further in reference to log entry processing block 1108 can update a producer consumer table for current set of call log data entries being processed. According to one aspect, orchestrator 110 for each API call log entry of a set of processed log entries can record services referenced in the log entry as being a “data producer” or a “data consumer” applying various rules-based logic as set forth herein.

On completion of block 1108, orchestrator 110 can proceed to update block 1109. At update block 1109, orchestrator 110 can update producer consumer registry 2131 to include the most recent producer consumer table information from the most recent set of log entries processed at block 1108.

Also at update block 1109, orchestrator 110 can query with call data the trained predictive model 5102 trained block 1108, which in response can output service classification information, e.g., specifying a service referenced in the query call data as isCritical or notCritical. On querying the trained predictive model 5102, orchestrator 110 can update service classification registry 2132 of service characterizing registry 2130. Further at update block 1109, orchestrator 110 can update service evaluation registry 2133, e.g., with processes set forth in reference to Eq. 1 and/or Table E in dependence on current producer consumer data of producer consumer registry 2131 and current service classification data of service classification registry 2132.

A specific example of orchestrator 110 performing block 1108 is set forth in reference to FIG. 5. At block 812, orchestrator 110 can retrieve rest API call log entries from logging volume 2127 of data repository 108 produced by logging and monitoring process 114. API call log entries can include various data as depicted in Table C including, e.g., transaction ID, source identifier, endpoint identifier, API path identifier, and method. At block 814, orchestrator 110 can supplement and enrich retrieved API call log entry data with specifiers for services of a deployed application where a service identifier is absent from the log entry data. For performance of enriching a log entry to include a service identifier, orchestrator 110 can query service profiles registry 2129 produced by service profile generation module 816. Service profiles as explained with reference to Table A can include information, e.g., on service endpoints, API paths, and dependencies. At blocks 814 orchestrator 110 can search service profiles of API paths and endpoints referenced in a call log to recover service ID for a source and/or a target referenced in a call log where missing.

Based on the retrieval of service identifier information, orchestrator 110 at block 818 can establish a call dataset for each respective API call of a set of processed API log entries. A call dataset can include parsed field data from an original API call enriched by service identifiers. A call dataset can include, e.g., call dataset={transaction ID, API path, method, source service, target service and return code}.

On completion of block 818, orchestrator 110 can proceed to block 820. At block 820, orchestrator 110 can group all established call datasets established at block 818 by transaction ID. On completion of block 820, orchestrator 110 can proceed to block 822.

Referring to block 822, orchestrator 110 for all call datasets for a given transaction can extract a criticality status label, i.e., critical or not critical for each respective call dataset. At block 822, orchestrator 110 can establish a call status label in dependence on a return code for the call dataset being evaluated. Where the return code indicates call failure, orchestrator 110 at block 822 can record an “isCritical” label for the call dataset. Embodiments herein recognize that administrator users may discern anomalous conditions that may not result in message failure. Accordingly, user interface capability, e.g. on user interface 9102, can be provided to an administrator user to facilitate a user updating related service database 832. Related service database 832 permits an administrator user to specify particular service source-target pairs as being critical or not critical. At block 824, orchestrator 110 can assign the label “critical” to the call dataset where related services database 832 references the service pair as “critical”.

On completion of block 822, orchestrator 110 can proceed to block 824. At block 824, orchestrator 110 can query related service database 832 using service identifiers for a current call dataset being subject to labeling. If a referenced service pair of the current call label dataset being labeled is listed as “critical” within related service database 832, orchestrator 110 can label at block 824 the current call dataset as being critical with use of the “isCritical” label. If the current service pair of the current call dataset being subject to labeling at 824 is listed as not critical in related service database 832 and there is no error return code, e.g., response code of “failure” for the log entry, orchestrator 110 at block 824 can assign a “notCritical” label to the call dataset.

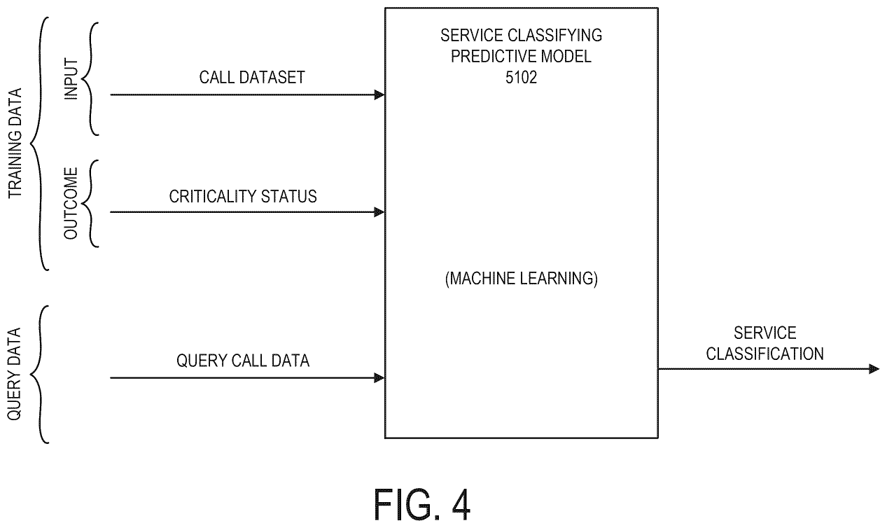

With the call datasets labeled at block 822 and 824, orchestrator 110 can use the labeled call datasets to perform machine learning training of a service classifying predictive model 5102 as set forth in reference to FIG. 4. Service classifying predictive model 5102, once trained, is able to return predictions as to criticality statuses when queried with representative call dataset data that references, e.g., a service and, optionally, additional information such as service pair information, API path and endpoint. Sufficiently trained, orchestrator 110 can deploy trained service classifying predictive model 5102 at block 830.

In another aspect of processing API call log entry processing at block 1108, orchestrator 110 at block 826 can update a producer consumer table 834. Embodiments herein recognize that log entries can be processed for recovery of information indicating whether a service was a data producer or a data consumer during a logged service call between services. At block 826, orchestrator 110 can return a classifier of a service as a producer or consumer in dependence on a method referenced in a call log entry being processed.

In one embodiment, orchestrator 110 can employ the decision data structure of Table D for performing classification of a call log entry in dependence on a method referenced in the call log, e.g., GET, POST, HEAD, PUT, PATCH, DELETE.

TABLE D

| Method | Description | Classification assignment |
|---|---|---|
| GET | Retrieve data | Source = C Target = P |
| POST | Send data | Source = P Target = C |
| HEAD | Retrieve metadata | Source = C Target = P |
| PUT | Update existing resource | Source = P Target = C |
| PATCH | Partially update resource | Source = P Target = C |
| DELETE | Remove resource | N |

P = Producer
C = Consumer
N = None

Based on the per call log analyzing at block 826, orchestrator 110 can update producer consumer table 834 to record the number of times that the service was a producer and the number of times that the service was a consumer in orchestrator's evaluation of call log entries at block 1108.

In reference to FIG. 5, orchestrator 110 at block 812 can retrieve REST API calls log entries from Logging service as stored in logging volume 2127. The logs can be generated by individual services, or Service Mesh. For each API call, orchestrator 110 at block 814 can identify the origin and target service. At block 814 based on query of service profile registry 2128, orchestrator 110 can identify API origin, the service invoking the API, and can Identify the target service, the service serving the API. For each API call, orchestrator 110 at block 818 can construct call dataset with the following structure: {txn-id, endpoint, api, method, source, target, ret code}. At block 820, orchestrator 110 can, from log get transaction status, group all call dataset by txn-id, where txn-id is transaction id, [txn-id: {status, [{endpoint, api, method, client, target, ret code}]].

For each transaction, orchestrator 110 at block 822 can iterate through list/group of call datasets and label the call dataset as critical if transaction status is failed and API return code (ret code) is 40× or 50× (error). Else, orchestrator 110 can label the call dataset as not-critical if transaction status is successful and API return code (ret-code) is 40× or 50× (error). At block 822, if the call dataset is not labeled critical, orchestrator 110 can check the service pair in related services database 832 and according to DB entry mark call dataset critical or not critical. Orchestrator 110 at block 826 can update producer consumer table 834, train predictive model 5102 with the labels generated at block 822, and block 824, and can save the predictive model 5102 into models area 2125.

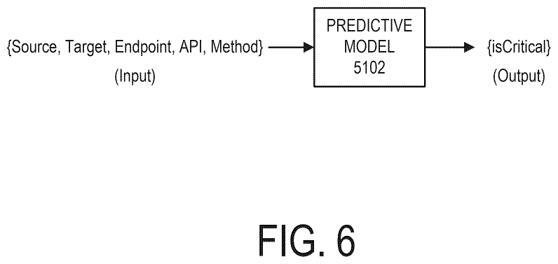

FIG. 6 depicts querying of service classifying predictive model 5102 according to one embodiment. As depicted in FIG. 6, orchestrator 110 can query predictive model 5102 with query call data including source, target, API, and method. In another user case, orchestrator 110 can query predictive model 5102 with query call data including source, target. In response to the query, service classifying predictive model 5102 can return the prediction as to whether services referenced in the query call data have the status of isCritical or notCritical.

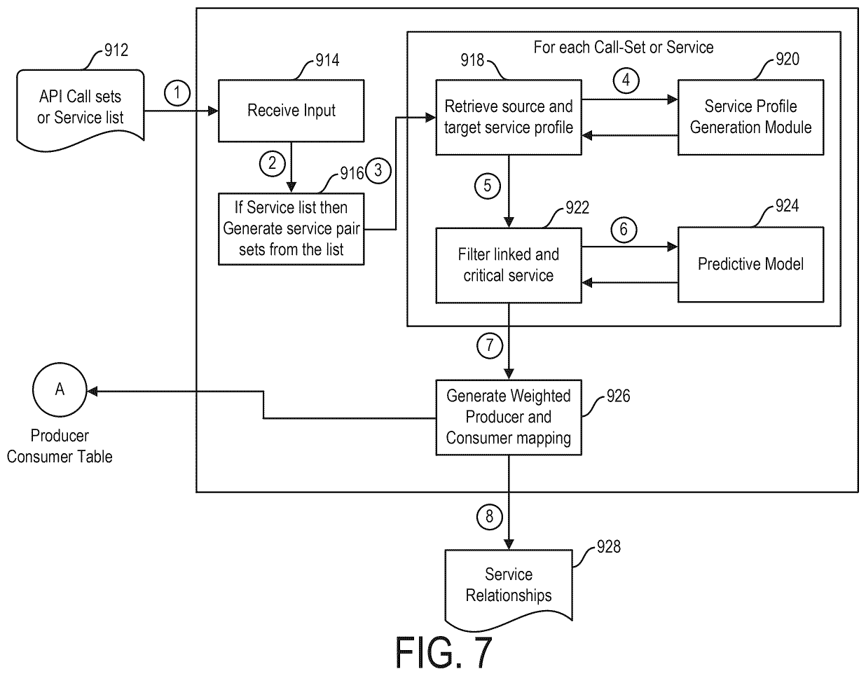

Now referring to FIG. 7, service classifying predictive model 5102 can be queried with sets of queries, each query having call data that specifies attributes of call, e.g., one or more service, an endpoint, an API path. In response, predictive model 5102 can output isCritical/notCritical classification predictions for multiple services. Where queried with multiple queries associated respectively to multiple calls, predictive model 5102 can output a criticality status prediction for the pair of services referenced in each call of the multiple calls.

Referring to FIG. 7, orchestrator 110 at blocks 912 and 914 can receive as inputs call datasets defining call data or service lists. If a service list is received, orchestrator 110 can generate pairs of services (service pairs) to generate call data from the service list, and orchestrator 110 can proceed to block 918.

At block 918 and 920, orchestrator 110 can enrich the call data of the input call datasets or service lists via referencing service profile data from service profile registry 2128. For enriching an instance of call data, orchestrator 110 can add service identifier(s) to call data based on extracted data from the service profile registry 2128, wherein service identifiers are associated to endpoint identifiers and API path identifiers. At block 922 and 924, orchestrator 110 can query service classifying predictive model 5102 using the call data of the input call sets or service list. In response, for each instance of call data applied as query data, predictive model 5102 can output a predicted criticality status (isCritical or notCritical) of services that are referenced in the call data.

In a further aspect of block 914, orchestrator 110 can obtain call datasets defining call data or list of services expressed in terms of service identifiers, endpoints and/or API paths. From the service list, orchestrator 110 at block 916 can generate the service pair set {svcX, svcY} defining call data. For each call dataset {source, target, endpoint, api, method} or the service pair {svcX, svcY}, orchestrator 110 at blocks 918 and 920 can pass a call dataset defining call data or a service pair defining call data to service profile registry 2129 which in response provides, for enrichment of the call data, a service identifier of the source and service identifier of the target where absent. At blocks 922 and 924, via query of service classifying predictive model 5102, orchestrator 110 can identify and filter critical services. At block 922, orchestrator 110 can query service classifying predictive model 5102 with query call data defined by call datasets or service pairs, and predictive model 5102 can return a classification of isCritical or notCritical for services referenced in the call data. At block 926, orchestrator 110 can generate weighted producer and consumer mappings based on producer consumer data from producer consumer registry 2131. At block 928, orchestrator 110 can output data defining service relationships.

In one embodiment, the service list applied at blocks 912 and 914 can include all services defining an application. Where there are ten services defining the application, there are 45 unique pairs of services. First and second queries from each pair can be constructed to express each service as a source, and a target in a service pair. Based on the 90 queries, predictive model 5102 can return the prediction as to whether each pair isCritical or notCritical.

Orchestrator 110 can characterize a service's criticality in dependence on a data from producer consumer registry of service characterizing registry 2130 with use of Eq. 1

$$S = F 1 W 1 + F 2 W 2 + F 3 W 3 \qquad ( Eq . 1 )$$

Where S is a total criticality score (scale, degree) assigned to a particular service being evaluated F1, F2, F3 are factors, and weight W1-W3 are weights associated to the various factors.

According to one embodiment, F1 can be a criticality percentage factor. In service pair queries involving a particular service, the service may be predicted isCritical for only a percentage of the queries, not all queries. Orchestrator 110 can scale scoring values under factor F1 in dependence on the percentage of queries involving a certain service returning the prediction isCritical. Factor 2 can be a producer ratio factor. Orchestrator 110 can scale scoring values under factor F2 in dependence on a producer/consumer ratio, e.g., can scale scoring values to scaled values over 0.5 in dependence on the producer/consumer ratio where the service was determined to be a producer in more instances than being found to be a consumer, and can scale scoring values under factor F2 to scaled values below 0.5 where the service was found to be a consumer in more instances than a producer. Factor F3 can be volume factor. Orchestrator 110 can scale scoring values under factor F3 in dependence on a ratio of producer counts associated to the service in the producer consumer registry to the overall number of producer counts (from all services) in the registry. In another embodiment, factor F1 can be dropped. In such an embodiment, any query returning the output of isCritical drives the classification of “critical” for a (even if predictive model 5102 outputs notCritical for some call data queries). In such an embodiment, Eq. 1 results in scaled producer scores (in the range of 0.5 to 1.0) or scaled consumer scores (in the range of 0.0 to 0.5) being assigned to a service.

Alternative logic for characterizing services in dependence on a service classification output (isCritical, notCritical) is shown in Table E below.

TABLE E

| | |
|---|---|
| 1. | Iterate through ServiceList {{Consumer:SvcX, Producer:SvcY, isCritical:true/false}] |
| | to construct a Service List with Occurrence-As-Consumer(oac), Occurrence-As-Producer(oap) and |

Critical Frequency

Initialize FrequencyList: [SvcA: {oac=0, oap=0, critical-freq=0}, SvcB: {oac=0, oap=0,

critical-freq=0}, . . .]

```
  for svc-pair in [{Consumer:SvcX, Producer:SvcY, isCritical:true/false}] list do
    Cons = svc-pair[Consumer]
    Prod = svc-pair[Producer]
```

FrequencyList[Cons]−>oac = FrequencyList[Cons]−>oac + 1
FrequencyList[Prod]−>oap = FrequencyList[Prod]−>oap + 1

if svc-pair−>isCritical == true then

crit-freq = 1

else

crit-freq = 0

FrequencyList[Cons]−>critical-freq = FrequencyList[Cons]−>critical-freq + crit-freq
FrequencyList[Prod]−>critical-freq = FrequencyList[Prod]−>critical-freq + crit-freq

| | |
|---|---|
| 2. | Remove the Services from the FrequencyList list with critical-freq == 0 or oap == 0 |
| 3. | Calculate the average |
| | average = sum of (critical-freq for all service in FrequencyList) / number of services in |

FrequencyList

| 3. | Adjust critical-freq in FrequencyList | |
|---|---|---|
| | W1 = 1.3 | |
| | W2 = 1.2 | |
| | 3.1 | For any service Sve if FrequencyList[Svc]−>critical-freq < average and oac > 0 and oap > 0 |

then

| | |
|---|---|
| | FrequencyList[Svc]−>critical-freq = FrequencyList[Svc]−>critical-freq X W1 |
| 3.2 | And, for any service Svc if FrequencyList[Svc]−>critical-freq < (average * 0.5) |

Get the list of Service pairs from ServiceList where Svc is participating as Producer
If any Service Pair has Call Frequency > average of Call Frequency ((in Producer Consumer

Table D)
then FrequencyList[Svc]−>critical-freq = FrequencyList[Svc]−>critical-freq X W1

| | |
|---|---|
| 4. | Re-order the services in the FrequencyList list with lowest critical-freq at index=1 and highest |

critical-freq at index=(number of services in the List)

| | |
|---|---|
| 5. | Assigning rank to Services in FrequencyList starting with index=1 and rank=1 |
| | if two service have same critical-freq then they will get same rank |

It will be seen that various processes can be employed for generating service evaluation data for storage into service evaluation registry 2133. Evaluation data can include, e.g., a ranked ordered list of services defining an application, e.g., as set forth in reference to Eq. 1 and Table E. The output data output as a result of performance of Eq. 1 processing and/or Table E processing can be recorded to service evaluation registry 2133 of service characterizing registry 2130.

For generating holistic service characterizing data characterizing all services defining an application, orchestrator 110 can apply a service list defining all services defining an application for query of service classifying predictive model 5102. Based on the service list, orchestrator 110 can generate the possible service pairs and can apply call data defined by the service pairs as query data for querying service classifying predictive model 5102, as explained with reference to block 916.

In another use case, transaction data can be used to query service classifying predictive model 5102. In one example, orchestrator 110 based on a transactionID can recover from transactions registry 2128 calls defining a particular transaction and can process, parse, and enrich the calls to generate call query data by processes set forth herein. Orchestrator 110 can apply call data defined by the recovered call datasets defining a transaction to service classifying predictive model 5102 as query data, and service classifying predictive model 5102 can return classifying data classifying services referenced in call datasets of the transaction as critical or not critical. Orchestrator 110 can generate service evaluation service characterizing data for updating service evaluation registry 2133 based on the classifying data and on characterizing data of the producer consumer registry 2131 as most recently updated. Prior to query of service classifying predictive model 5102 with query date extracted from the consolidated transactions, orchestrator 110 can train service classifying predictive model 5102 on the consolidated transactions by applying enriched call datasets processed for call log entries from logging volume 2127 for historical instances of the consolidated transactions using the training data preparation processing set forth in reference to block 1108 of FIG. 3, and FIG. 5.

Orchestrator 110 can generate holistic service characterizing data characterizing a holistic set of services defining an application, in one embodiment, e.g., by (a) consolidating all transactions executed during the deployment of an application, (b) training service classifying predictive model 5102 using labeled call datasets produced via processing of call log entries referencing the consolidated transactions as set forth in reference to block 1108 of FIG. 3, and FIG. 5, (c) using transactionIDs for the consolidated transactions to recover based on calls stored in transactions registry 2128, call data for the consolidated transactions, (d) querying service classifying predictive model 5102 for return of classifications of services referenced in the call datasets of the consolidated transactions, and (e) updating service characterizing registry 2130 in dependence on the predicted classifications and on data of producer consumer registry 2131 as most recently updated.

On completion of update block 1109 at which orchestrator 110 can update service characterizing registry 2130, orchestrator 110 can determine whether the deployment period for the current application has ended. For a time that the deployment period has not ended, orchestrator 110 can iteratively perform the loop of block 1102-1110 so that log entries continue to be processed for facilitating iteratively updating of service characterizing registry by processes of blocks 1107-1109. On determination at block 1110 that a deployment period has ended, orchestrator 110 can proceed to return block 1111. At return block 1111, orchestrator 110 can return to stage preceding block 1101 to wait for next request data. It will be understood that orchestrator 110 can be performing multiple instances of the loop of block 1101-1111 concurrently for multiple applications. On-premises computer environment 150A can be iteratively performing the loop of block 1501-1505 for a deployment period of on-premises computer environment 150A. Computer environments 140A-140Z can be iteratively performing the loop of blocks 1401-1404 for a deployment period of computer environments 140A-140Z.

In one aspect, orchestration registry 2126 can store parameter values configuring scaling and/or load balancing orchestration processes. Orchestrator 110 running scaling and load balancing process 115 can update scaling and/or load balancing processes to modify a performance attribute of one or more service in dependence on characterizing data of service characterizing registry 2132. In one embodiment, orchestrator 110 in response to classification of a service changing to critical or satisfying a scoring threshold under the Eq. 1 and/or Table E processing can update a scaling process associated to the service, e.g., increasing a minimum instance count, and/or maximum instance count for scaling of the service as specified in service orchestration registry 2126, can generate one or more call for performance of the action, and can execute the one or more call. In one embodiment, orchestrator 110 in response to classification of a service changing to critical or satisfying a scoring threshold under the Eq. 1 and/or Table E processing can update a load balancing process associated to the service, e.g., can increase frequency of health checks on instances of the service as specified in service orchestration registry 2126, can generate one or more call for performance of the action, and can execute the one or more call. In one embodiment, orchestrator 110 in response to classification of a service changing to critical or satisfying a scoring threshold under the Eq. 1 and/or Table E processing can update a load balancing process associated to the service, e.g., can decrease a session duration limit on instances of the service as specified in service orchestration registry 2126, can generate one or more call for performance of the action, and can execute the one or more call.

In one embodiment, orchestration registry 2126 can store parameter values specifying attributes of a disaster recovery plan orchestration process, and orchestrator 110 running recovery process 116 can be configured to update orchestration registry 2126 to modify a performance attribute of one or more service in dependence on service characterizing data of service characterizing registry 2132. In one embodiment, orchestration registry 2126 can record as a recovery plan parameter value data specifying an order of services to be subject to failover rehosting in the event of a disaster, and orchestrator 110 running recovery process 116 can update orchestration registry 2126 so that the order of services to be subject to failover rehosting is updated in dependence on service characterizing data of service characterizing registry 2130, e.g., in accordance with a ranked order of services in the service characterizing registry 2132, e.g., so that higher ranking services are subject to failover rehosting before relatively lower ranking services. In one embodiment, orchestration registry 2126 can record an order of services to be subject to data replicating in the event of a disaster, and orchestrator 110 running recovery process 116 can update orchestration registry 2126 so that the order of services to be subject to data replicating is updated in dependence on service characterizing data of service characterizing registry 2130, e.g., in accordance with a ranked order of services in the service characterizing registry 2132, e.g., so that higher ranking services are subject to data replicating before relatively lower ranking services.

Orchestrator 110 running recovery process 116 can update a recovery plan to modify a performance attribute of one or more service in a variety of additional ways in dependence on characterizing data of service characterizing registry 2132. In one embodiment, orchestrator 110 in response to classification of a service changing to critical or satisfying a scoring threshold under the Eq. 1 and/or Table E processing can update a failover process associated to the service, e.g., from manual failover to automatic failover as specified in service orchestration registry 2126, can generate one or more call for performance of the action, and can execute the one or more call. In one embodiment, orchestrator 110 in response to classification of a service changing to critical or satisfying a scoring threshold under the Eq. 1 and/or Table E processing can update a data replication process associated to the service, e.g., can increase a rate of replication data to a backup storage volume as specified in service orchestration registry 2126, can generate one or more call for performance of the action, and can execute the one or more call. In one embodiment, orchestrator 110 in response to classification of a service changing to critical or satisfying a scoring threshold under the Eq. 1 and/or Table E processing can update a recovery point objective (RPOs) associated to the service as specified in service orchestration registry 2126, can generate one or more call for performance of the action, and can execute the one or more call. In one embodiment, orchestrator 110 in response to classification of a service changing to critical or satisfying a scoring threshold under the Eq. 1 and/or Table E processing can register threshold exceeding resource utilization (CPU, working memory, storage memory) of the service as a disaster indicating event triggering disaster recovery as specified in service orchestration registry 2126, can generate one or more call for performance of the action, and can execute the one or more call.

Referring again to criterion block 1105, orchestrator 110 can determine whether a criterion has been satisfied triggering orchestrator 110 to access and retrieve characterizing data of service characterizing registry 2130. In one embodiment, orchestrator 110 at criterion block 1105 can determine whether a recovery process has been triggered. For determining that a recovery process has been triggered orchestrator 110 can, e.g., processing incoming log entry to discern that a log entry indicative of a disaster has been recorded, and or can examine metrics data indicating resource utilization of specified services. On determination that a recovery condition is present, orchestrator 110 can proceed to access block 1113 to access service characterizing registry 2130 as most recently updated and can update orchestration registry 2126 based on the service characterizing data of service characterizing registry 2130. In some embodiments, orchestration registry 2126 can be automatically updated by updating service characterizing registry. At block 1114, orchestrator 110 can return an action decision to modify a performance attribute of one or more service in dependence on the characterizing data of service characterizing registry 2130. The action decision can be to perform recovery failover operations and/or data replicating in accordance with an ordering of services as determined from service characterizing registry 2130. At block 1115 action in accordance with the action decision can be initiated, e.g. orchestrator 110 can generate one or more call for performance of the action. At send block 1116 and 1117, orchestrator 110 can send call data to on premises computer environment 150A and/or appropriate ones of computer environments 140A-140Z for performance of the action and on premises computer environment 150A and/or appropriate ones of computer environments 140A-140Z can perform action in accordance with the action decision at action blocks 1504 and 1403 respectively. Depending on configuration and/or one or more condition, orchestrator 110 at access block 1113 can be configured to update service characterizing registry 2130 prior to access of service characterizing registry 2130, e.g., by performance of block 1107, 1108 and 1109 prior to access of service characterizing registry 2130 prior at block 1113.

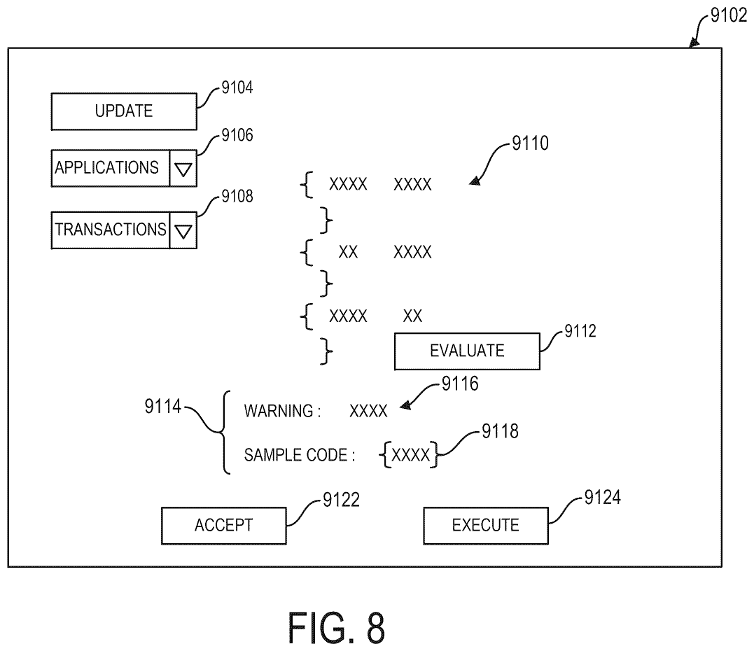

Additional aspects of features of herein are set forth in reference to user interface 9102 as set forth in reference to FIG. 8 which can be used by an administrator user of system 100, e.g., an agent user of a tenant associated to an on-premises computer environment, or an administrator user agent user of orchestrator 110. User interface 9102 can be displayed on a UE device of UE devices 130A-130Z associated to an administrator user. In one aspect, user interface 9102 can include update button 9104. In response to update button 9104 being activated, according to one example, orchestrator 110 can update a current scaling and/or load balancing process for a specified application which can be selected using menu 9108. In response to update button 9104 being activated, according to one example, orchestrator 110 can update a current recovery plan orchestration process for a specified application which can be selected using menu 9108.

The activation of button 9104 can trigger satisfaction of criterion of criterion block 1105. On activation of button 9104, according to one example, orchestrator 110 can proceed to access block 1113, where, prior to access of service characterizing registry 2130, orchestrator 110 can update service characterizing registry 2130 by performing block 1107, 1108, and 1109. Orchestrator 110 at action decision block 1114 can render an action decision for updating a scaling and/or load balancing process to modify a performance attribute of one or more service and responsively to the action decision actions and call messaging can proceed appropriately at blocks 1115, 1116, 1117, 1504, and 1403. In one embodiment, orchestrator 110 in response to classification of a service changing to critical or satisfying a scoring threshold under the Eq. 1 and/or Table E processing can update a scaling process associated to the service, e.g., increasing a minimum instance count, and/or maximum instance count for scaling of the service as specified in service orchestration registry 2126, can generate one or more call for performance of the action, and can execute the one or more call. In one embodiment, orchestrator 110 in response to classification of a service changing to critical or satisfying a scoring threshold under the Eq. 1 and/or Table E processing can update a load balancing process associated to the service, e.g., can increase frequency of health checks on instances of the service as specified in service orchestration registry 2126, can generate one or more call for performance of the action, and can execute the one or more call. In one embodiment, orchestrator 110 in response to classification of a service changing to critical or satisfying a scoring threshold under the Eq. 1 and/or Table E processing can update a load balancing process associated to the service, e.g., can decrease a session duration limit on instances of the service as specified in service orchestration registry 2126, can generate one or more call for performance of the action, and can execute the one or more call.

The activation of button 9104 can trigger satisfaction of criterion of criterion block 1105. On activation of button 9104, according to one example, orchestrator 110 can proceed to access block 1113, where, prior to access of service characterizing registry 2130, orchestrator 110 can update service characterizing registry 2130 by performing block 1107, 1108, and 1109. Orchestrator 110 at action decision block 1114 can render an action decision for updating a recovery plan to modify a performance attribute of one or more service and responsively to the action decision actions and call messaging can proceed appropriately at blocks 1115, 1116, 1117, 1803, and 1804. In one embodiment, orchestrator 110 in response to classification of a service changing to critical or satisfying a scoring threshold under the Eq. 1 and/or Table E processing can update a failover process associated to the service, e.g., from manual failover to automatic failover as specified in service orchestration registry 2126, can generate one or more call for performance of the action, and can execute the one or more call. In one embodiment, orchestrator 110 in response to classification of a service changing to critical or satisfying a scoring threshold under the Eq. 1 and/or Table E processing can update a data replication process associated to the service, e.g., can increase a rate of replicating data to a backup storage volume as specified in service orchestration registry 2126, can generate one or more call for performance of the action, and can execute the one or more call. In one embodiment, orchestrator 110 in response to classification of a service changing to critical or satisfying a scoring threshold under the Eq. 1 and/or Table E processing can update a recovery point objective (RPOs) associated to the service as specified in service orchestration registry 2126, can generate one or more call for performance of the action, and can execute the one or more call. In one embodiment, orchestrator 110 in response to classification of a service changing to critical or satisfying a scoring threshold under the Eq. 1 and/or Table E processing can register threshold exceeding resource utilization (CPU, working memory, storage memory) of the service as a disaster indicating event triggering disaster recovery as specified in service orchestration registry 2126, can generate one or more call for performance of the action, and can execute the one or more call.

Where orchestrator 110 as part of updating an orchestration process involving, e.g., scaling, load balancing, recovery identifies for reconfiguring a service hosted on a third-party computer environment, orchestrator 110 may not have permissions to send a call to the service for implementing the reconfiguration. In such use cases, orchestrator 110 in lieu of sending calls can send promoting data notifications to the third-party computer environment, e.g., with sample call text, prompting the third-party computer environment to perform the identified reconfiguring.

In another aspect, user interface 9102 can be used to evaluate and edit transactions comprising multiple calls. In response to an administrator user selecting a particular transaction using menu 9108, a criterion of criterion block 1105 can be triggered, and orchestrator 110 can proceed to access block 1113, where orchestrator 110, prior to where prior to access of service characterizing registry 2130 can update service characterizing registry 2130 by performing block 1107, 1108 (based on most recent available logging data), and 1109 (which can be triggered by a user activating evaluate button 9112 of user interface 9102).

In reference again to user interface 9102, user interface 9102 can display at development area 9110 calls defining an historical transaction being evaluated. For updating service characterizing registry 2130 in the described scenario, orchestrator 110, e.g., on activation of evaluate button 9112, can parse required call dataset data from calls defining a transaction, and can input the call dataset data as input query data into predictive model 5102. In response, as explained in reference to FIGS. 5-7, predictive model 5102 can output predicted classifications for services referenced in the query call data, and orchestrator 110 can perform evaluating in dependence on producer consumer registry data, e.g., including ordered ranking of the services with use of processes such as those described with reference to Eq. 1 and/or Table E.

In response to evaluating, user interface 9102 can present user prompting data 9114. User prompting data can include, e.g., warning text 9116 and sample call text area 9118. The warning text 9116 can warn of a change in status to critical of one or more service referenced in calls defining a transaction. The warning text 9116 alternatively or additionally can warn of a change in scoring and/or ranking of a service relative to other services referenced in calls defining a transaction. The sample call text 9118 can specify one or more sample call for modifying a performance attribute of one or more service which may be useful for executing based on the warning referenced in the sample code text. One or more sample call, can include, e.g., a call to update a scaling process, a call to update a load balancing process, a call to update a failover process associated to a service (from manual to automatic), a call to increase a rate at which data of a service is replicated to a backup storage volume, a call to update an RPO objective, a call to register threshold exceeding resource utilization (CPU, working memory, storage memory) of the service as a disaster indicating event as described with reference to orchestration registry 2126. User interface 9102 can include accept button 9122 which when activated results in orchestrator 110 incorporating any prompted for call of area 9118 being incorporated into a transaction and execute button 9124 which when activated results in the edited transaction being executed. In one embodiment, the updating of a transaction to include the one or more prompted for call and the executing of the automatically updated and edited call can occur automatically responsively, e.g., to a transaction being selected using menu 9108. Calls herein can modify a performance attribute of one or more service.

Various available tools, libraries, and/or services can be utilized for implementation of trained predictive models herein trained by machine learning. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. According to one possible implementation, a machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. Trained predictive models herein can employ use, e.g., of artificial neural networks (ANNs), random forests, support vector machines (SVM), Bayesian networks, and/or other machine learning technologies.

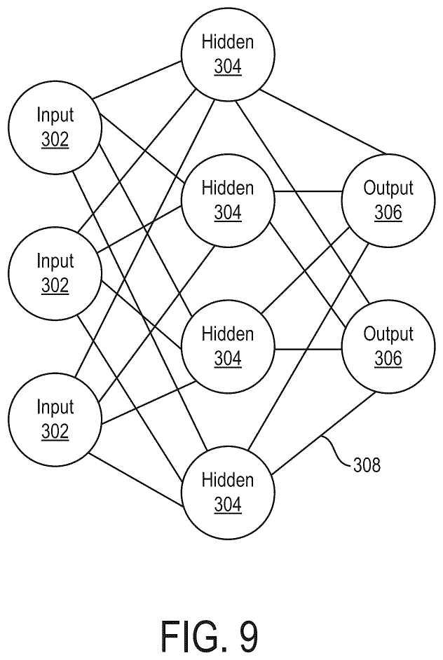

FIG. 9 is an illustration of an example ANN architecture for trained predictive models herein.

One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons.

Referring now to FIG. 9, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 302 that provide information to one or more “hidden” neurons 304. Weighted connections 308 between the input neurons 302 and hidden neurons 304 are weighted, and these weighted inputs are then processed by the hidden neurons 304 according to some function in the hidden neurons 304. There can be any number of layers of hidden neurons 304, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 306 accepts and processes weighted input from the last set of hidden neurons 304.

This represents a “feed-forward” computation, where information propagates from input neurons 302 to the output neurons 306. Upon completion of a feed-forward computation, the output is compared to a desired output available from training data. The error relative to the training data is then processed in “backpropagation” computation, where the hidden neurons 304 and input neurons 302 receive information regarding the error propagating backward from the output neurons 306. Once the backward error propagation has been completed, weight updates are performed, with the weighted connections 308 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output, which can be referred to as outcome training data as referenced in connection with service classifying predictive model 5102 herein. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process can continue until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, weights of weighted connections 308 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, weights of weighted connections 308 may be implemented as resistive processing units (RPUs), generating a predictable current output when an input voltage is applied in accordance with a settable resistance.

Certain embodiments herein may offer various technical computing advantages involving computing advantages to address problems arising in the realm of computer systems. Embodiments herein can analyze call traffic between services defining an application, and based on the analysis can generate service characterizing data that can control one or more process. In one aspect, call log entries as recorded in a logging volume can be employed to train a predictive model, and the trained predictive model can be queried with call data to return a criticality classifier for one or more service referenced in the call data. In a further aspect evaluative data of a service can be generated with use of a criticality classifier of the service and information from an iteratively updated producer consumer registry. With use of processes herein service characterizing data can be derived, even with respect to services hosted on third party computer environments not being operated either by a tenant user requester or an orchestrator entity. Service characterizing data can be iteratively updated to drive updates to wide range of orchestration processes, including, e.g., scaling orchestration processes, load balancing orchestration processes, and recovery orchestration processes. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

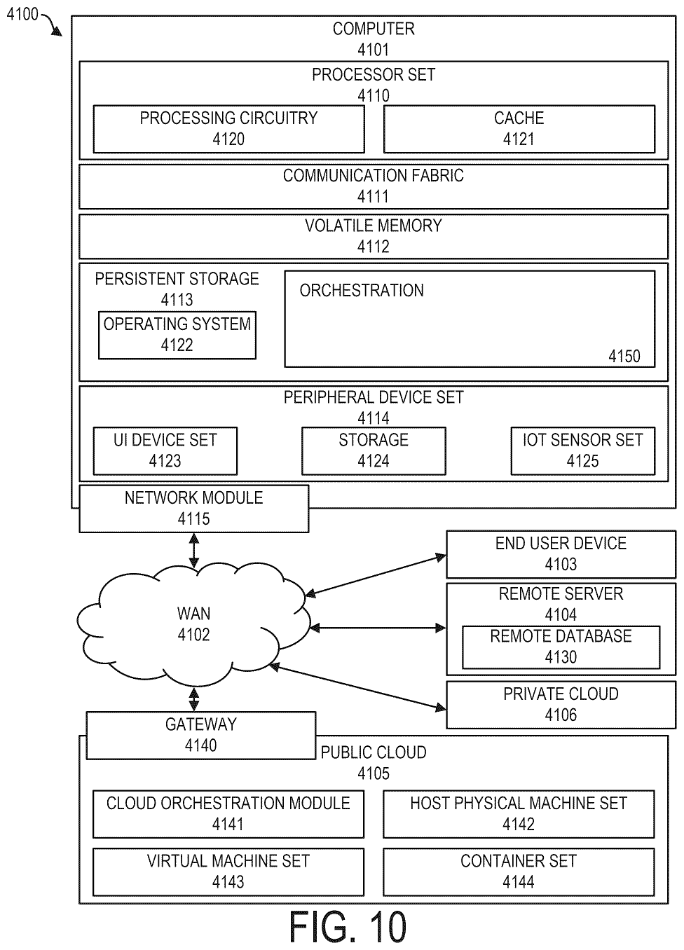

In reference to FIG. 10 there is set forth a description of a computing environment 4100 that can include one or more computer 4101. In one example, computing node 10 as set forth herein can be provided in accordance with computer 4101 as set forth in FIG. 10.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Hash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 10. In one aspect, a computing environment 4100 contains an example of an environment for the execution of at least some of the computer code involved in performing the inventive methods, such as code 4150 for performing orchestration as set forth in FIGS. 1-9. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid-state storage devices. Operating system 4122 may take several forms, such as various known proprietary operating systems or open-source Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101) and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements but is not limited to possessing only those one or more steps or elements. Likewise, a step of a method or an element of a device that “comprises,” “has,” “includes,” or “contains” one or more features possesses those one or more features but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
training a machine learning model in dependence on traffic between at least a first service and a second service defining an application;
querying the machine learning model;
generating service characterizing data that characterizes at least one service defining the application, wherein the generating the service characterizing data is in dependence on the querying of the machine learning model; and
modifying a performance attribute of the application in dependence on characterizing data of the service characterizing data.

2. The computer implemented method of claim 1, wherein the method includes processing call log entries from a logging data volume and generating from the processing labeled call datasets.

3. The computer implemented method of claim 1, wherein the method includes examining call log entries from a logging data volume to generate producer consumer data that specifies a count of instances in which the at least one service defining the application operated as a producer and a count of instances in which the at least one service defining the application operated as a consumer.

4. The computer implemented method of claim 1, wherein the method includes processing call log entries from a logging data volume, and generating from the processing labeled call datasets, wherein the call log entries reference calls between services hosted on one or more computer environment, and wherein the training the machine learning model includes training the machine learning model with use of the labeled call datasets.

5. The computer implemented method of claim 1, wherein the method includes processing application program interface (API) documentation using natural language processing to generate service profile data of a plurality of services defining the application, wherein the service profile data associates at least one of an endpoint or API path to service identifiers of respective ones of the plurality of services, wherein the method includes processing call log entries from a logging data volume, and generating from the processing labeled call datasets that are enriched with service identifiers extracted by query of the service profile data, wherein the call log entries reference calls between services hosted on one or more computer environment, and wherein the training the machine learning model includes training the machine learning model with use of the labeled call datasets.

6. The computer implemented method of claim 1, wherein the method includes processing return code data of call log entries from a logging data volume, and generating from the processing labeled call datasets, wherein labels of the labeled call datasets depend on the return code data processed by the processing, wherein the call log entries reference calls between services hosted on one or more computer environment, and wherein the training the machine learning model includes training the machine learning model with use of the labeled call datasets.

7. The computer implemented method of claim 1, wherein the method includes examining call log entries from a logging data volume to generate producer consumer data defining the service characterizing data that specifies a count of instances in which the at least one service defining the application operated as a producer and a count of instances in which the at least one service defining the application operated as a consumer, and wherein the generating the service characterizing data is in dependence on the examining.

8. The computer implemented method of claim 1, wherein the method includes processing call log entries from a logging data volume, and generating from the processing labeled call datasets, wherein the call log entries reference calls between services hosted on one or more computer environment, wherein the training the machine learning model includes training the machine learning model with use of the labeled call datasets, wherein the querying of the machine learning model produces a criticality status classifier for the at least one service defining the service characterizing data, wherein the method includes examining call log entries from a logging data volume to generate producer consumer data defining the service characterizing data that specifies a count of instances in which the at least one service defining the application operated as a producer and a count of instances in which the at least one service defining the application operated as a consumer, wherein the generating the service characterizing data is in dependence on the examining, wherein the modifying the performance attribute of the application in dependence on characterizing data of the service characterizing data includes modifying the performance attribute of the application in dependence on the criticality status classifier and in dependence on the producer consumer data.

9. The computer implemented method of claim 1, wherein the modifying the performance attribute of the application in dependence on characterizing data of the service characterizing data includes updating an orchestration process of the application.

10. The computer implemented method of claim 1, wherein the modifying the performance attribute of the application in dependence on characterizing data of the service characterizing data includes updating a recovering plan for recovery of the application, wherein the updating the recovering plan for recovery of the application includes executing a call to increase a data replication rate at which data of the at least one service is replicated into a backup storage volume.

11. A system comprising:
a memory;
at least one processor in communication with the memory; and
program instructions executable by one or more processor via the memory to perform a method comprising:
training a machine learning model in dependence on traffic between at least a first service and a second service defining an application;
querying the machine learning model;
generating service characterizing data that characterizes at least one service defining the application, wherein the generating the service characterizing data is in dependence on the querying of the machine learning model; and
modifying a performance attribute of the application in dependence on characterizing data of the service characterizing data.

12. The system of claim 11, wherein the method includes processing call log entries from a logging data volume and generating from the processing labeled call datasets.

13. The system of claim 11, wherein the method includes examining call log entries from a logging data volume to generate producer consumer data that specifies a count of instances in which the at least one service defining the application operated as a producer and a count of instances in which the at least one service defining the application operated as a consumer.

14. The system of claim 11, wherein the method includes processing call log entries from a logging data volume, and generating from the processing labeled call datasets, wherein the call log entries reference calls between services hosted on one or more computer environment, and wherein the training the machine learning model includes training the machine learning model with use of the labeled call datasets.

15. The system of claim 11, wherein the method includes examining call log entries from a logging data volume to generate producer consumer data defining the service characterizing data that specifies a count of instances in which the at least one service defining the application operated as a producer and a count of instances in which the at least one service defining the application operated as a consumer, and wherein the generating the service characterizing data is in dependence on the examining.

16. The system of claim 11, wherein the method includes processing call log entries from a logging data volume, and generating from the processing labeled call datasets, wherein the call log entries reference calls between services hosted on one or more computer environment, wherein the training the machine learning model includes training the machine learning model with use of the labeled call datasets, wherein the querying of the machine learning model produces a criticality status classifier for the at least one service defining the service characterizing data, wherein the method includes examining call log entries from a logging data volume to generate producer consumer data defining the service characterizing data that specifies a count of instances in which the at least one service defining the application operated as a producer and a count of instances in which the at least one service defining the application operated as a consumer, wherein the generating the service characterizing data is in dependence on the examining, wherein the modifying the performance attribute of the application in dependence on characterizing data of the service characterizing data includes modifying the performance attribute of the application in dependence on the criticality status classifier and in dependence on the producer consumer data.

17. The system of claim 11, wherein the modifying the performance attribute of the application in dependence on characterizing data of the service characterizing data includes updating a recovering plan for recovery of the application.

18. The system of claim 11, wherein the modifying the performance attribute of the application in dependence on characterizing data of the service characterizing data includes updating a recovering plan for recovery of the application, wherein the updating the recovering plan for recovery of the application includes executing a call to increase a data replication rate at which data of the at least one service is replicated into a backup storage volume.

19. The computer implemented method of claim 11, wherein the method includes processing application program interface (API) documentation using natural language processing to generate service profile data of a plurality of services defining the application, wherein the service profile data associates at least one of an endpoint or API path to service identifiers of respective ones of the plurality of services, wherein the method includes processing call log entries from a logging data volume, and generating from the processing labeled call datasets that are enriched with service identifiers extracted by query of the service profile data, wherein the call log entries reference calls between services hosted on one or more computer environment, and wherein the training the machine learning model includes training the machine learning model with use of the labeled call datasets.

20. A computer program product comprising:
a computer readable storage medium readable by one or more processing circuit and storing instructions for execution by one or more processor for performing a method comprising:
training a machine learning model in dependence on traffic between at least a first service and a second service defining an application;
querying the machine learning model;
generating service characterizing data that characterizes at least one service defining the application, wherein the generating the service characterizing data is in dependence on the querying of the machine learning model; and
modifying a performance attribute of the application in dependence on characterizing data of the service characterizing data.
